(19) United States
(12) Patent Application Publication
(10) Pub. No.: US 2006/0226245 A1
(43) Pub. Date: Oct. 12, 2006

(54) Encoding format for passive radio frequency identification (RFID) system

(75) Inventor: Chi-Ho Hsu, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Holtek Semiconductor Inc., Hsinchu (TW)

(21) Appl. No.: 11/375,438

(22) Filed: Mar. 14, 2006

(30) Foreign Application Priority Data
Apr. 12, 2005 (TW) 094111581

(51) Int. Cl. G06K 19/06

(52) U.S. Cl. 235/494

(57) ABSTRACT

An encoding format for a radio frequency identification system is provided. The encoding format includes a low-level pulse of one unit length and a high-level pulse of n unit length, wherein the value of n is adjusted to constitute different command/data formats.

### FIELD OF THE INVENTION

The present invention relates to an encoding format, and more particularly to an encoding format for a passive radio frequency identification system (RFID).

### BACKGROUND OF THE INVENTION

Due to the limitation of the application field and cost consideration, the passive radio frequency identification system is unable to be operated with a complicated communication modulation. Therefore, the amplitude modulation (AM) is commonly used to perform the data transmission. Besides, there is no active power supply at the tag of the passive RFID system. Hence, at the tag, the radio frequency (RF) carrier sent from the reader is regarded as the AC power input signal to perform the AC/DC power conversion. That is to say, the data transmission is completed under a limited power supply.

Please refer to FIG. 1, which shows the structure of the passive RFID system in the prior art. The electromagnetic induction is proceeded through the inductors L101 and L111 respectively implicit in the reader 01 and the tag 02, so that the energy and information can be transmitted there between two side The inductor L101 is implicit in the resonance circuit 10 of the reader 01, and the inductor L111 is implicit in the resonance circuit 11 of the tag 02. The fixed radio frequency carrier signal emitted from the inductor L101 of the reader 01 is induced by the inductor L111 of the tag 02 and then serves as an AC power source. After that, the AC power source is converted into a DC voltage via the bridge rectifier circuit 12, which may be a full-wave bridge rectifier circuit composed of four diodes, or a half-wave bridge rectifier circuit 12 composed of two diodes. Then, a stable DC level is obtained via the RC low-pass filter 13 which provides a required DC voltage source for the oscillating circuit 15 and the digital logic circuit 16 of the tag 02. Accordingly, a system clock pulse is generated by the oscillating circuit 15 of the tag 02 in response to the provided voltage. The data to be transmitted is encoded and then modulated and sent out via the modulation circuit 17. When received by the reader 01, the transmitted data is demodulated by a detection circuit and then sent to a Micro-Controlloer Unit (MCU). Therefore, a predetermined corresponding operation can be performed by the MCU so as to accomplish the signal transmission.

In the conventional passive RFID system, since the whole RFID system is not operated within a fixed distance, the amplitude sensed by the antenna of the tag 02 varies with the distance between the reader 01 and the tag 02. In the mean time, the DC level converted by the bridge rectifier circuit 12 also varies correspondingly. Therefore, when the AM transmission is performed in the conventional passive RFID system, the numerical encoding is always performed therewith so as to avoid errors in the AM demodulation process. Commonly, the numerical encoding may be a pulse width modulation (PWM) encoding.

Please refer to FIG. 2, which shows the data transmission in the passive read only RFID system in the prior art. As shown in FIG. 2, the reader sends a carrier with a fixed amplitude waveform signal. At the tag, the AC/DC converter converts the RF amplitude to provide the tag system enough power (tag_VDD) for normal operation (the tag_VDD is over minimum operating voltage of tag). The tag encodes the data to be sent out through the PWM encoding, and then the PWM encoding signal is modulated with the carrier signal and sent to the antenna. Concurrently, the reader detects and demodulates the carrier waveform to decode and generate the correct data information. While the tag modulates the carrier signal, the tag_VDD always needs to be over the minimum operating voltage of the tag.

Please refer to FIG. 3, which shows the data transmission in the passive read/write RFID system in the prior art. As shown in FIG. 3, in the reading mode, the data sent from the tag is read by the reader, and the reading method thereof is the same as that of the passive read only RFID system. That is to say, the tag encodes the data to be sent through the PWM encoding, and then the data to be sent is modulated with the carrier and then sent to the reader.

When the reader intends to write data to the tag, it encodes the data and modulates and sends out them via the antenna. Because the writing data exist high/low bit variation, so the tag terminal will detect and convert the modulated signal to the DC power, which is lower than that of the tag of the passive read only RFID system. Then, the DC power is used for demodulating the data and a serial relative action is accomplished.

In the operation of the passive read only RFID system, the antenna of the reader sends a radio frequency carrier signal with a fixed amplitude as an AC power source for the tag. Then, the operating voltage for the tag is obtained through conversion by the rectifier and filter circuits in the tag. Simultaneously, the data to be sent is modulated with the carrier so that it is received by the reader, thereby accomplishing one-way data transmission. However, for the passive read/write RFID system, the reader sends the radio frequency carrier signal with digital data in an AM transmission mode. Thus, after the data modulation, the amplitude of the sent radio frequency carrier is changeable for the tag to demodulate. The converted operating voltage tag_VDD for the tag has to be higher than the minimum operating voltage therefor.

Please refer to FIG. 4, which shows the data transmission in the PWM read/write RFID system in the prior art. As shown in FIG. 4, the conventional PWM read/write RFID system performs the encoding in a PWM format. For example, LHHH represents DATA “1” and HLLL represents data “0”. If successive high-level pulses occur, a higher DC level VDD1_L would be converted by the tag. Contrarily, a lower DC level VDD0_L would be converted by the tag if successive low-level pulses occur. In any event, VDD1_L and VDD0_L both have to be higher than the minimum operating voltage for the tag to avoid the malfunction. Therefore, by using the conventional PWM encoding method, when the distance between the reader and the tag is too long or when the reader sends successive low-level carriers, the DC bias converted by the tag would be insufficient, leading to the malfunction of the tag. Further, the applied distance between the tag and the reader would be shortened due to the insufficient DC bias.

Please refer to FIG. 5, which shows the PPM encoding method in the prior art. The PPM encoding method defines different commands based on the position of the low-level pulse. The advantage of the PPM encoding method lies in that it only uses a low-level pulse with one unit length, which could reduce the decline degree of the DC voltage converted by the tag. Take FIG. 5 for example, a command has sixteen unit lengths, where the low-level pulse occupies one unit length and the high-level pulse occupies fifteen unit lengths. In this way, the BAUD rate between the tag and the reader could be reduced. However, since different commands are defined based on the position of the low-level pulse, it is very important to determine the position of the low-level pulse correctly. Nevertheless, in practical operation, it is unable to determine the initial point of the low-level pulse at once. Hence, a complicated position locking action has to be performed for avoiding the incorrectness. This increases the complexity of the PPM demodulation circuit.

In order to overcome the drawbacks in the prior art, an encoding format for a passive radio frequency identification system is provided. The particular design in the present invention not only solves the problems described above, but also is easy to be implemented. Thus, the present invention has the utility for the industry.

### SUMMARY OF THE INVENTION

In accordance with one aspect of the present invention, an encoding format for a passive radio frequency identification system is provided. The encoding format combines the transmission characteristic of the PWM data encoding with that of the PPM data encoding to provide a specific encoding format for performing the data transmission with a specific format protocol. The encoding format also has a simple demodulation function and could enlarge the applied distance of the passive RFID system under its limited power supply.

In accordance with another aspect of the present invention, an encoding format for a radio frequency identification system is provided. The encoding format includes a low-level pulse of one unit length and a high-level pulse of n unit length, wherein a value of n is adjusted to constitute different command/data formats.

Preferably, the radio frequency identification system is a passive radio frequency identification system.

Preferably, the encoding format is used for an amplitude modulation (AM) of the passive radio frequency identification system.

Preferably, n is greater than or equal to 1.

Preferably, the command/data format is constituted by the high-level pulse of n unit length.

Preferably, the command/data format is constituted by the low-level pulse of one unit length and the high-level pulse of n unit length.

Preferably, the command/data format is constituted by a plurality of high-level pulses of different unit lengths between two successive low-level pulses of one unit length.

Preferably, the low-level pulse of one unit length is an initial point of the command/data format.

In accordance with a further aspect of the present invention, an encoding format for a radio frequency identification system is provided. The encoding format includes a low-level pulse of one unit length and a high-level pulse of n unit length, wherein a value of n is adjusted to constitute different command/data formats, and the command/data format is constituted by the high-level pulse of n unit length.

Preferably, the radio frequency identification system is a passive radio frequency identification system.

Preferably, the encoding format is used for an amplitude modulation of the passive radio frequency identification system.

Preferably, n is greater than or equal to 1.

Preferably, the low-level pulse of one unit length is an initial point of the command/data format.

In accordance with further another aspect of the present invention, an encoding format for a radio frequency identification system is provided. The encoding format includes a low-level pulse of one unit length and a high-level pulse of n unit length, wherein a value of n is adjusted to constitute different command/data formats, and the command/data format is constituted by the low-level pulse of one unit length and the high-level pulse of n unit length.

Preferably, the radio frequency identification system is a passive radio frequency identification system.

Preferably, the encoding format is used for an amplitude modulation of the passive radio frequency identification system.

Preferably, n is greater than or equal to 1.

Preferably, the low-level pulse of one unit length is an initial point of the command/data format.

In accordance with further another aspect of the present invention, an encoding format for a radio frequency identification system is provided. The encoding format includes a low-level pulse of one unit length and a high-level pulse of n unit length, wherein a value of n is adjusted to constitute different command/data formats, and the command/data format is constituted by a plurality of high-level pulses of different unit lengths between two successive low-level pulses of one unit length.

Preferably, the radio frequency identification system is a passive radio frequency identification system.

Preferably, the encoding format is used for an amplitude modulation of the passive radio frequency identification system.

Preferably, n is greater than or equal to 1.

Preferably, the low-level pulse of one unit length is an initial point of the command/data format.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the structure of the passive RFID system in the prior art;

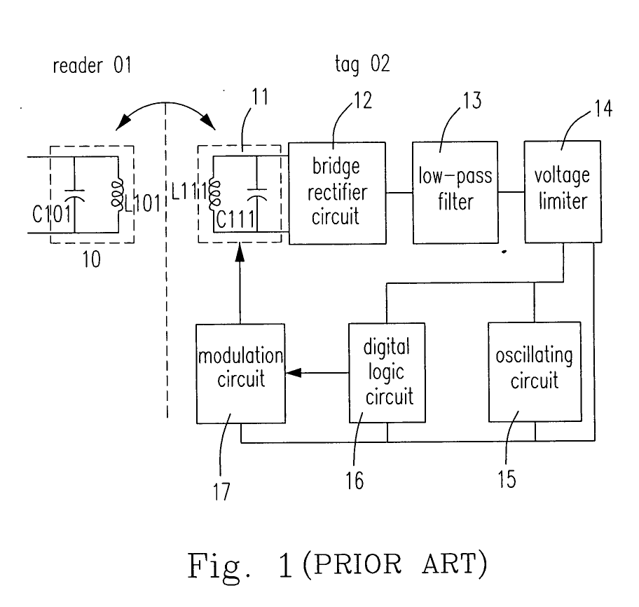

FIG. 2 shows the data transmission in the passive read only RFID system in the prior art;

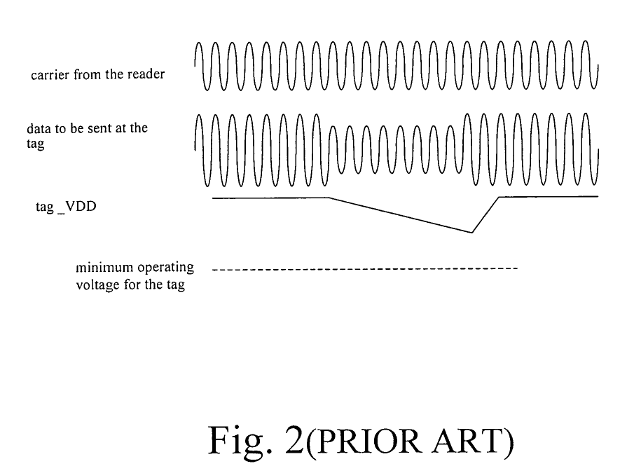

FIG. 3 shows the data transmission in the passive read/write RFID system in the prior art;

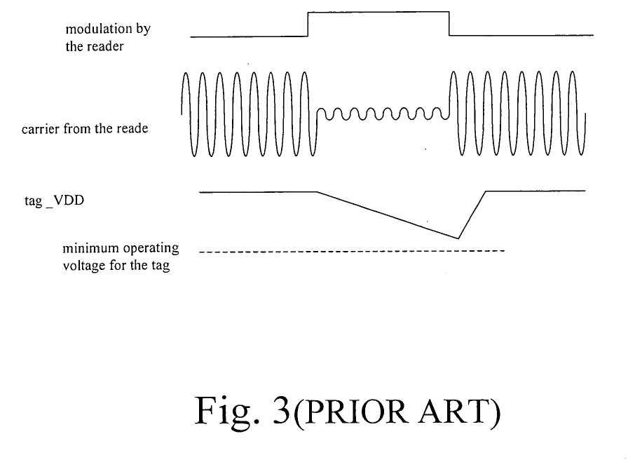

FIG. 4 shows the data transmission in the PWM read/write RFID system in the prior art;

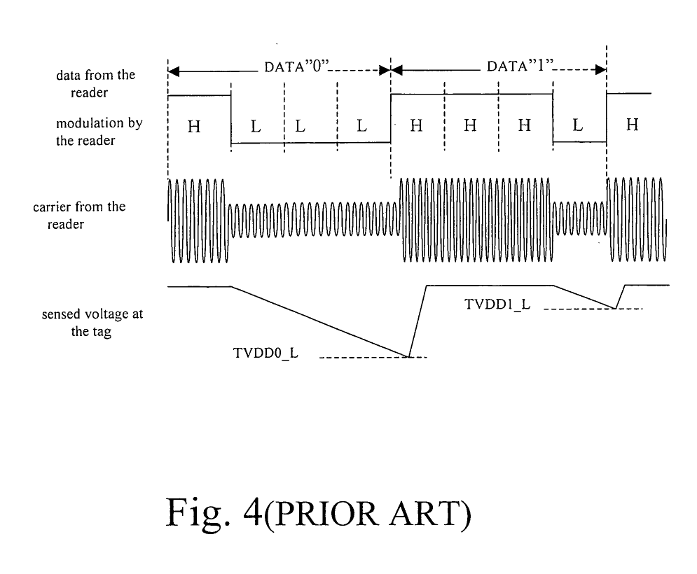

FIG. 5 shows the PPM encoding method in the prior art;

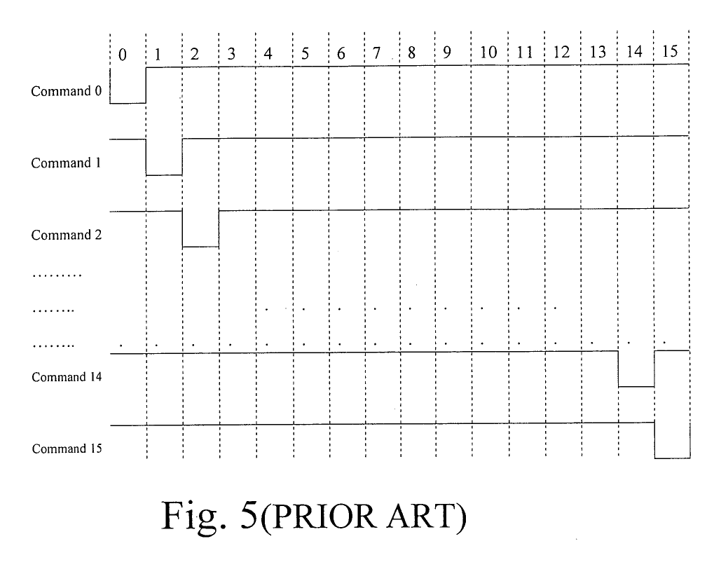

FIG. 6 shows the data transmission in the passive RFID system according to a preferred embodiment of the present invention;

FIG. 7 shows the encoding method according to a preferred embodiment of the present invention; and

FIG. 8 shows a complete transmission structure according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

The present invention provides a communication transmission interface suitable for the passive RFID to perform two-way communication, which combines the transmission characteristic of the PWM data encoding and that of the PPM data encoding. The present invention adopts the characteristic of the single low-level pulse in the PPM data encoding and that of the different lengths encoding in the PWM data encoding, and utilizes the distance between two non-successive low-level pulses to represent different commands or data. In this way, different commands or data could be designed for data transmission.

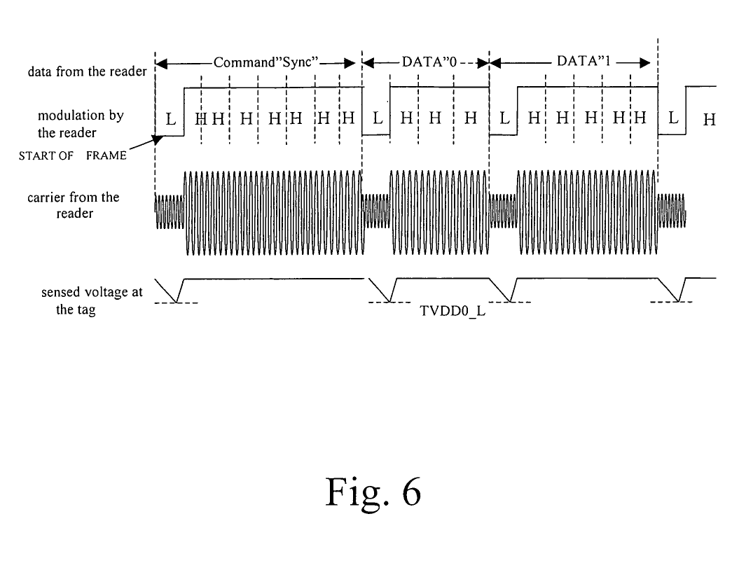

Please refer to FIG. 6, which shows the data transmission in the passive RFID system according to a preferred embodiment of the present invention. As shown in FIG. 6, each command or datum starts with a low-level pulse of one unit length, with the cooperation of a subsequent high-level pulse of n unit length. That is to say, the number of high-level pulses is used to represent different commands or data. In other words, the distance between two successive low-level pulses is used to represent different commands or data.

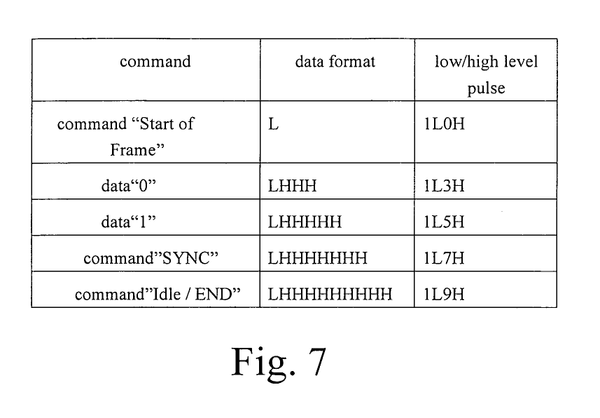

Please refer to FIG. 7, which shows the encoding method according to a preferred embodiment of the present invention. As shown in FIG. 7, each command or datum starts with a low-level pulse of a minimum unit length that is acceptable by the tag. Therefore, when the command or data is demodulated, the low-level pulse is detected for system clock adjustment. By using the low-level pulse as the initial point of the command or data and subsequently measuring the number of the unit lengths of the high-level pulse, the meaning of the command or data could be simply determined.

Because only one low-level pulse of one unit length exists in the encoding format of each command or datum, the voltage decline of the DC power for the tag is constant, thereby minimizing the influence of the voltage decline. Namely, the applied distance of the present invention is longer than that of the conventional PWM encoding format.

Basically, the PPM encoding method is unable to provide the initial point of the command or data to be detected. However, in the encoding method of the present invention, each command or datum starts with a low-level pulse of a minimum unit length that is acceptable by the tag. Therefore, when the command or data is demodulated, the low-level pulse is detected for system clock adjustment. By using the low-level pulse as the initial point of the command or data and subsequently measuring the number of the unit lengths of the high-level pulse, the meaning of the command or data could be simply determined. Since the unit lengths of each command or datum are variable, the user could define different commands or data based thereon. Compared to the conventional PPM encoding method which uses the command or data of fixed unit lengths, the present invention has a much faster transmission rate.

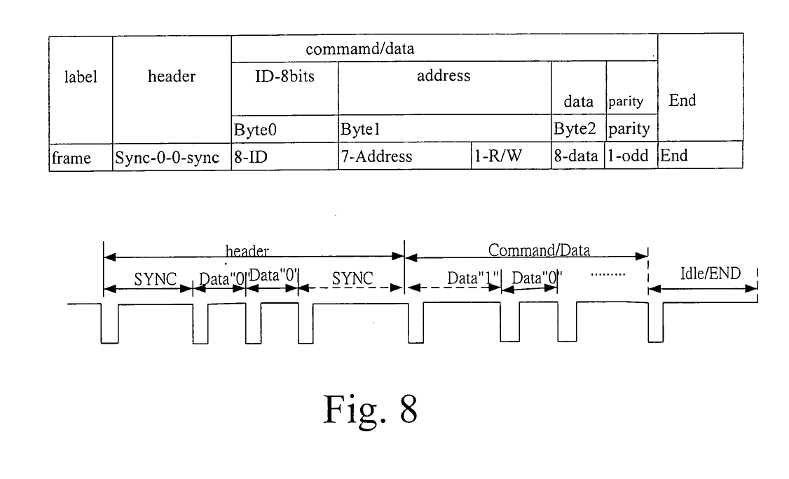

Please refer to FIG. 8, which shows a complete transmission structure according to a preferred embodiment of the present invention. The complete transmission structure is divided into three blocks, including a header, a command/data and an End. The header is composed of SYNC, Data “0”, Data “0” and SYNC, and starts with a low-level pulse. The SYNC is composed of a high-level pulse of seven unit lengths, and the Data “0” is composed of a high-level pulse of three unit lengths. After the header is received by the receiving terminal, the clock adjustment at the receiving terminal could be performed to determine the encoding commands such as “Data_L” and “Data_H”, etc. The command/data block is composed of an 8-bit ID, a 7-bit address, a read/write bit, 8-bit data and an odd parity bit. The encoding command “End” exists in the end of the complete transmission structure.

In conclusion, the present invention provides an encoding format for a passive radio frequency identification system. The encoding format combines the transmission characteristic of the PWM data encoding with that of the PPM data encoding to provide a specific encoding format for performing the data transmission with a specific format protocol. The encoding format also has a simple demodulation function and could enlarge the applied distance of the passive RFID system under its limited power supply. Besides, the transmission rate of the present invention is much faster than that of the conventional encoding methods. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An encoding format for a radio frequency identification system, comprising:
a low-level pulse of one unit length and a high-level pulse of n unit length, wherein a value of n is adjusted to constitute different command/data formats.

2. The encoding format as claimed in claim 1, wherein the radio frequency identification system is a passive radio frequency identification system.

3. The encoding format as claimed in claim 2, being used for an amplitude modulation (AM) of the passive radio frequency identification system.

4. The encoding format as claimed in claim 1, wherein n is greater than or equal to 1.

5. The encoding format as claimed in claim 1, wherein the command/data format is constituted by the high-level pulse of n unit length.

6. The encoding format as claimed in claim 1, wherein the command/data format is constituted by the low-level pulse of one unit length and the high-level pulse of n unit length.

7. The encoding format as claimed in claim 1, wherein the command/data format is constituted by a plurality of high-level pulses of different unit lengths between two successive low-level pulses of one unit length.

8. The encoding format as claimed in claim 1, wherein the low-level pulse of one unit length is an initial point of the command/data format.

9. An encoding format for a radio frequency identification system, comprising:
a low-level pulse of one unit length and a high-level pulse of n unit length, wherein a value of n is adjusted to constitute different command/data formats, and the command/data format is constituted by the high-level pulse of n unit length.

10. The encoding format as claimed in claim 9, wherein the radio frequency identification system is a passive radio frequency identification system.

11. The encoding format as claimed in claim 10, being used for an amplitude modulation of the passive radio frequency identification system.

12. The encoding format as claimed in claim 9, wherein n is greater than or equal to 1.

13. The encoding format as claimed in claim 9, wherein the low-level pulse of one unit length is an initial point of the command/data format.

14. An encoding format for a radio frequency identification system, comprising:
a low-level pulse of one unit length and a high-level pulse of n unit length, wherein a value of n is adjusted to constitute different command/data formats, and the command/data format is constituted by the low-level pulse of one unit length and the high-level pulse of n unit length.

15. The encoding format as claimed in claim 14, wherein the radio frequency identification system is a passive radio frequency identification system.

16. The encoding format as claimed in claim 15, being used for an amplitude modulation of the passive radio frequency identification system.

17. The encoding format as claimed in claim 14, wherein n is greater than or equal to 1.

18. The encoding format as claimed in claim 14, wherein the low-level pulse of one unit length is an initial point of the command/data format.

19. An encoding format for a radio frequency identification system, comprising:
a low-level pulse of one unit length and a high-level pulse of n unit length, wherein a value of n is adjusted to constitute different command/data formats, and the command/data format is constituted by a plurality of high-level pulses of different unit lengths between two successive low-level pulses of one unit length.

20. The encoding format as claimed in claim 19, wherein the radio frequency identification system is a passive radio frequency identification system.

21. The encoding format as claimed in claim 20, being used for an amplitude modulation of the passive radio frequency identification system.

22. The encoding format as claimed in claim 19, wherein n is greater than or equal to 1.

23. The encoding format as claimed in claim 19, wherein the low-level pulse of one unit length is an initial point of the command/data format.
